(19) United States
(12) Patent Application Publication
(10) Pub. No.: US 2004/0205716 A1
(43) Pub. Date: Oct. 14, 2004

(54) System and method for adapting non-SCCS files to SCCS file repository

(76) Inventors: Hassan Elhag Abdel-Rahman, Broomfield, CO (US); Robert R. Peterson, Broomfield, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/413,788

(22) Filed: Apr. 14, 2003

(51) Int. Cl. G06F 9/44; G06F 12/00

(52) U.S. Cl. 717/120; 717/169; 707/200

(57) ABSTRACT

A system, method and computer program product for adapting non-SCCS files to an SCCS file repository is disclosed. The method may be implemented as a process executable on a suitable computer processor. A plurality of non-SCCS files are received at a computer, e.g., in a ZIP file. The SCCS file repository is searched and files matching the received non-SCCS files are retrieved from the SCCS file repository. The matching files from the SCCS file repository are compared to the received non-SCCS files and the SCCS files are updated if the comparison indicates that they have been changed.

### BACKGROUND

1. Field of the Invention

The present invention relates to electronic computer systems, and more particularly to a computer-based process for adapting non-SCCS files to an SCCS file repository.

2. Background

Many UNIX developers store source code in a Source Code Control System (SCCS) file repository. For various reasons, it may be necessary to integrate files that are not stored in an SCCS file repository into the source code files that are stored in the SCCS repository. By way of example, subcontractors may be used to develop new source code and/or to modify existing source code. These subcontractors may use an operating environment that does not use an SCCS file repository, such that source code shipped by these subcontractors may not be compatible with the SCCS file repository.

Accordingly, there is a need in the art for systems and methods for adapting non-SCCS files for use in an SCCS file repository.

### SUMMARY

In an exemplary embodiment, a method for adapting non-SCCS files for use in an SCCS file repository is described. The method comprises receiving a plurality of non-SCCS files; retrieving from an SCCS file repository files matching the received plurality of non-SCCS files; comparing the received non-SCCS files to the SCCS files; updating files in the SCCS file repository for which the non-SCCS files reflect changes; and saving the updated files in the SCCS file repository.

In another embodiment, a computer program product executable on a processor for adapting non-SCCS files for use in an SCCS file repository is described. The computer program product comprises a computer usable medium having computer readable code embodied therein for managing resources. The computer usable medium comprises logic instructions for receiving a plurality of non-SCCS files; logic instructions for retrieving from an SCCS file repository files matching the received plurality of non-SCCS files; logic instructions for comparing the received non-SCCS files to the SCCS files; logic instructions for updating files in the SCCS file repository for which the non-SCCS files reflect changes; and logic instructions for saving the updated files in the SCCS file repository.

In another embodiment, a system for adapting non-SCCS files for use in an SCCS file repository is described. The system comprises a network interface for receiving a plurality of non-SCCS files from a remote computing device; and a processor adapted to execute logic instructions embodied on a computer readable medium, to retrieve from an SCCS file repository files matching the received plurality of non-SCCS files, to compare the received non-SCCS files to the SCCS files, to update files in the SCCS file repository for which the non-SCCS files reflect changes; and to save the updated files in the SCCS file repository.

### BRIEF DESCRIPTION OF THE DRAWINGS

FIG. 1 is a schematic illustration of adapting non-SCCS files to an SCCS file repository;

FIG. 2 is a flowchart illustrating an exemplary process for adapting non-SCCS files to an SCCS file repository;

FIG. 3 is a flowchart illustrating portions of the process in FIG. 2 in greater detail;

FIG. 4 is a block diagram of a general-purpose computer system 400 suitable for carrying out a method for adapting non-SCCS files to an SCCS file repository.

### DETAILED DESCRIPTION

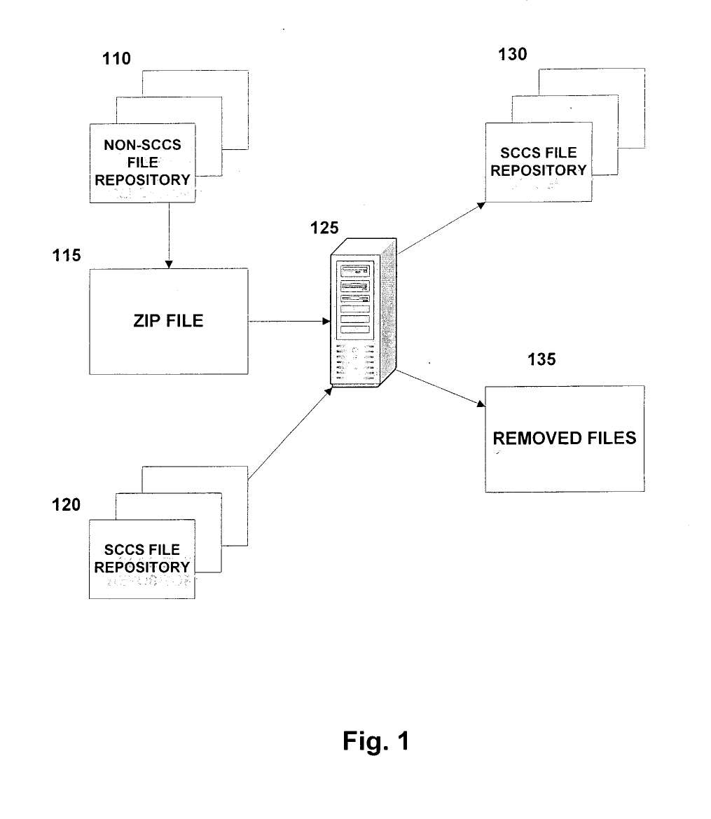

FIG. 1 is a schematic illustration of adapting non-SCCS files to an SCCS file repository. Referring to FIG. 1, a non-SCCS file repository 110 (e.g., CVS, Clear Case, etc.) comprising one or more files that are to be integrated into an SCCS repository 120 may be optionally combined into a ZIP file 115. Files from the SCCS repository 120 and the ZIP file are input into a process that resides as a computer executable, e.g., an executable UNIX shell script on a UNIX file system's hard drive. The executable script performs a series of operations to adapt the non-SCCS files to an SCCS file repository 130, and optionally generates a list of files removed in the non-SCCS file repository.

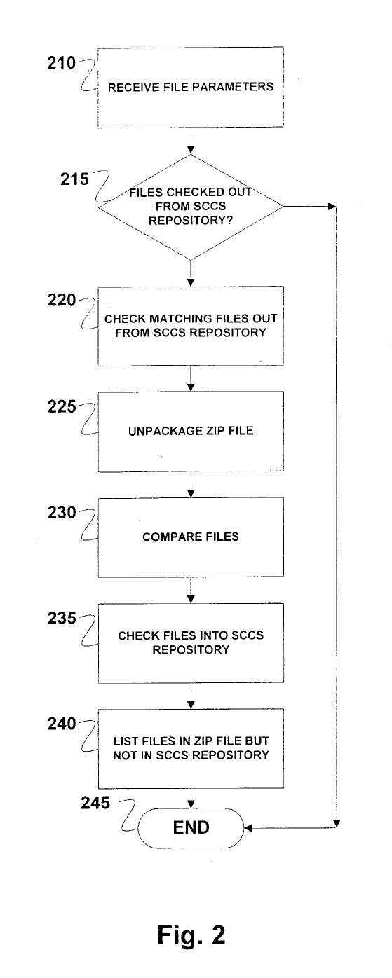

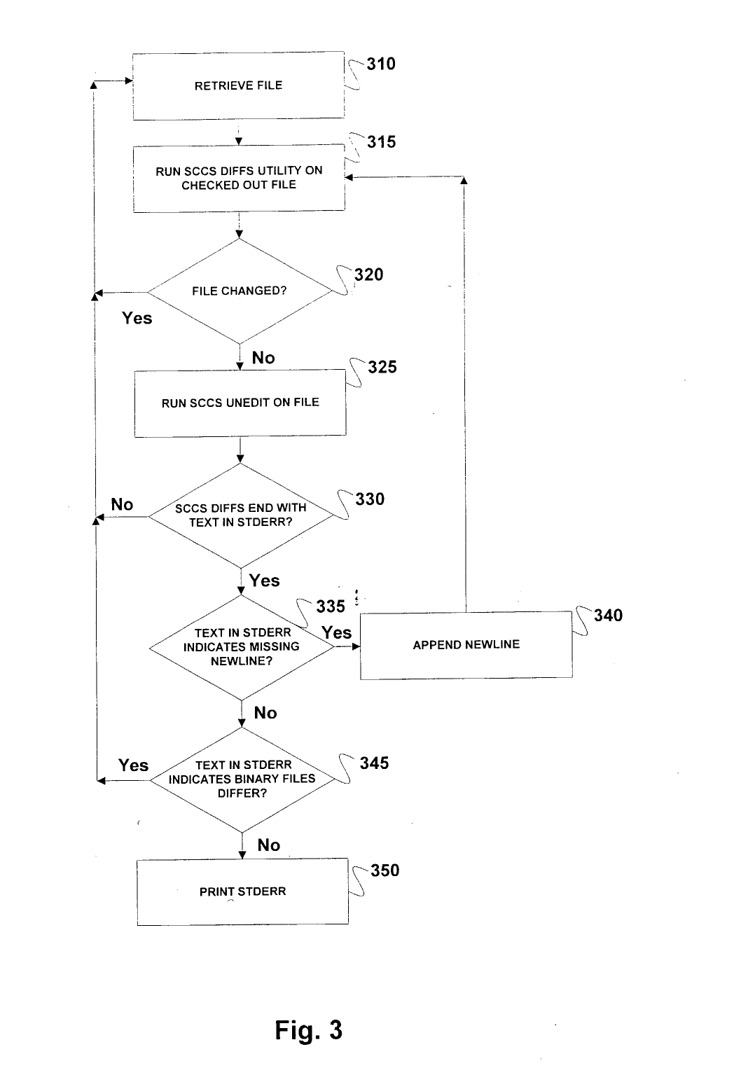

FIGS. 2-3 are flowcharts illustrating methods of implementing an exemplary process for adapting non-SCCS files to an SCCS file repository. In the following description, it will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block or blocks. The computer program instructions may also be loaded onto a computer or other programmable apparatus to cause a series of operational steps to be performed in the computer or on other programmable apparatus to produce a computer implemented process such that the instructions which execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

Referring to FIG. 2, the process begins at step 210, in which the process receives the file parameters. In an exemplary embodiment the file parameters may include the name of the file repository, the name of the ZIP file, and any comments that may be used for any files that are added to or updated in the file repository. Comments may reflect differences between the received code and the code in the existing code repository. For example, the comments may reflect that the received code fixes a particular bug identified in the existing code, or introduces a new component to the product.

At step 215 the process determines whether any files in the SCCS repository are checked out. In an exemplary embodiment, this may be performed by scanning all SCCS file subdirectories for files that begin with a ‘p.’. If files are checked out, then control passes to step 245 and the process ends. In an exemplary embodiment, a message may be displayed to the user of the system indicating which files must be checked in before the process may be executed. By contrast, if no files are checked out of the SCCS repository, then control passes to step 220.

At step 220 files matching those received in the ZIP file are checked out of the SCCS file repository. In an exemplary embodiment, this may be performed by obtaining a manifest of the ZIP file, e.g., by calling a zip -1 routine on the ZIP file. The manifest may be parsed to generate a list that includes only the filenames. Then the process may enter a loop that, for each file in the manifest, scans the SCCS repository and if the file is located in the SCCS repository, then the file is checked out. By contrast, if the file is not located, then the process loops to the next file in the manifest.

After the files have been checked out, control passes to step 225, and the ZIP file is unpackaged on top of the SCCS file repository. In an exemplary embodiment, this may be accomplished by first unzipping the ZIP file. The process then enters a loop that, for each file in the ZIP file, if the file name ends in a predefined type of ASCII suffix (e.g., .txt, Java, .css, .html, jsp, .css, .xml, .xsl, .sh., .ksh, .csh, .bat, etc.), the utility dos2unix is run on the file to convert the file from a DOS format to a UNIX format. Control then passes to step 230.

At step 230, the adapted files from the ZIP file are compared to the matching files in the SCCS file repository to determine whether there are differences between the files. FIG. 3 is a flowchart illustrating in greater detail the comparison process implement in step 230. In an exemplary embodiment, the process of FIG. 3 is executed in a loop that loops through each of the matching files. Referring to FIG. 3, at step 310 the first matching files are retrieved. At step 315 the process runs the SCCS diffs utility against the matching files. The SCCS diffs command compares the current revision of the file (i.e., the file received with the ZIP file) against the prior revision (i.e., the file checked out from the SCCS repository). At step 320, if the SCCS diffs utility indicates that the file is unchanged, then at step 325 an SCCS unedit utility is run on the file. The SCCS unedit command removes the unedited file, effectively rolling back the version change implemented when the ZIP file was unpackaged. By contrast, if the SCCS diffs utility indicates that the file has been changed, then control passes back to step 310 and the next file is retrieved.

If, at step 330 the process determines whether the SCCS diffs utility exited with test in the stderr file descriptor. If not, then control passes back to step 310 and the next file is retrieved. By contrast, if there is text in the stderr file descriptor, then at step 335 the process determines whether the text comprises an error message indicating that the newline designator is missing at the end of the file, e.g., “Warning: missing newline at end of file.” If this is the text, then control passes to step 340 and the process appends a newline to the end of the file to bring the file into conformity with the SCCS file format, e.g., by executing a redirection command to redirect an echo command to append to the end of a file. Control then passes back to step 315. By contrast, if this is not the text, then control passes to step 345.

At step 345 the process determines whether the whether the text comprises an error message indicating that the binary files differ, e.g., “Warning: binary files differ.” If the text in stderr indicates that the binary files differ, then control passes back to step 310 and the process is repeated for the next file in the list of files. By contrast, if the test in stderr does not indicate that the binary files differ, then control passes to step 350 and the stderr file descriptor is printed. Then control passes back to step 310 and the process is repeated for the next file in the list of files.

The process in FIG. 3 may be repeated for each of the matching files from the ZIP file and the SCCS file repository to complete the step 230. When completed, control may pass to step 235 and all the files may be checked into the SCCS repository. This may be implemented by executing a loop that examines each file in the SCCS repository and the ZIP file. If the file is checked out from the SCCS repository, then perform an SCCS delget operation on the file. In an exemplary embodiment, the determination of whether the file is checked out may be made by determining whether an SCCS meta file exists that begins with SCCS/p.<filename>. The delget operation may include any comment(s) specified from the command line. If no SCCS meta file exists, indicating that the file is not under SCCS control, then an SCCS create operation may be performed on the file to place the file under SCCS control. Control may then pass to step 240.

At step 240 the process generates a list of all files in the ZIP file that are not in the SCCS file repository. In an exemplary embodiment this step may be performed by executing loop that examines each file in the SCCS repository and determining if there is a corresponding file in the ZIP file manifest list generated in step 220 and appending the file name to a list of deleted files. It will be appreciated that the process need not examine files in the SCCS meta directories or the Teamware meta directories. The list of deleted files may then be printed, and the process may end at step 245.

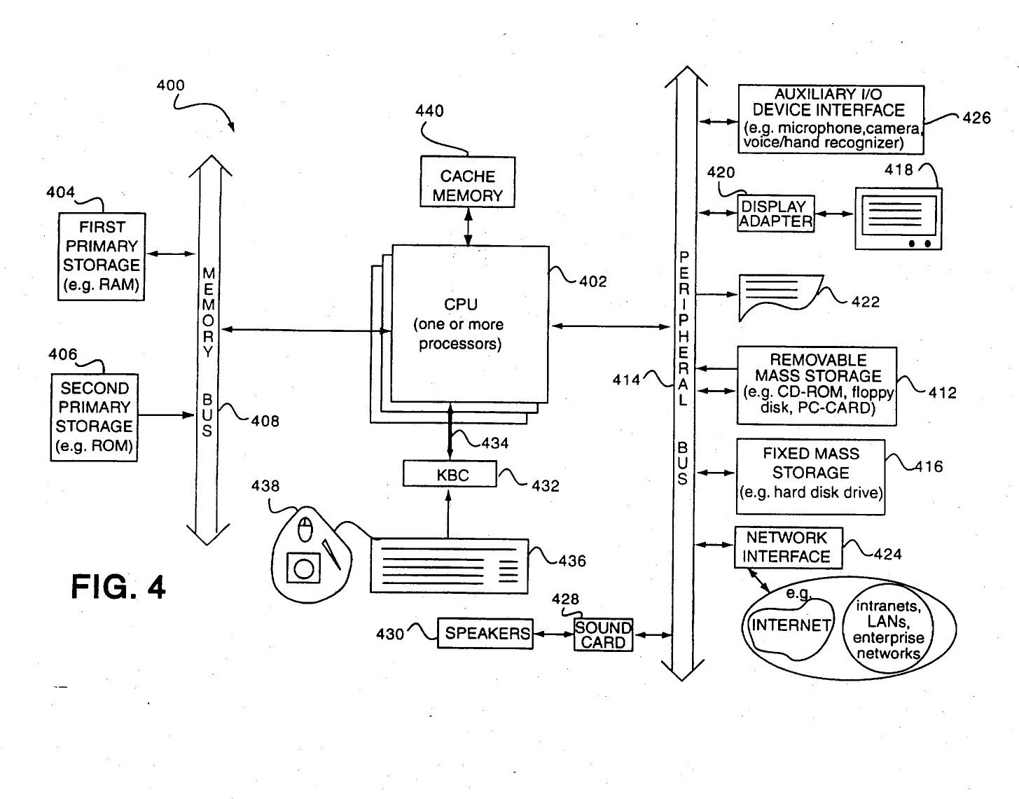

FIG. 4 is a block diagram of a general-purpose computer system 400 suitable for carrying out a method for operating system management as described above. FIG. 4 illustrates one embodiment of a general-purpose computer system. Other computer system architectures and configurations can be used for carrying out the processing of the present invention. Computer system 400, made up of various subsystems described below, includes at least one microprocessor subsystem (also referred to as a central processing unit, or CPU) 402. That is, CPU 402 may be implemented by a single-chip processor or by multiple processors. CPU 402 may be a general-purpose digital processor which controls the operation of the computer system 400. Using instructions retrieved from memory, the CPU 402 controls the reception and manipulation of input data, and the output and display of data on output devices.

CPU 402 may be coupled bi-directionally with a first primary storage 404, typically a random access memory (RAM), and uni-directionally with a second primary storage area 406, typically a read-only memory (ROM), via a memory bus 408. As is well known in the art, primary storage 404 may be used as a general storage area and as scratch-pad memory, and also may be used to store input data and processed data. It also may store programming instructions and data, in the form of threads and processes, for example, in addition to other data and instructions for processes operating on CPU 402, and may be used typically used for fast transfer of data and instructions in a bi-directional manner over the memory bus 408. Also as well known in the art, primary storage 406 typically includes basic operating instructions, program code, data and objects used by the CPU 402 to perform its functions. Primary storage devices 404 and 406 may include any suitable computer-readable storage media, described below, depending on whether, for example, data access needs to be bi-directional or uni-directional. CPU 402 may also directly and very rapidly retrieve and store frequently needed data in a cache memory 430.

A removable mass storage device 412 provides additional data storage capacity for the computer system 400, and is coupled either bi-directionally or uni-directionally to CPU 402 via a peripheral bus 414. For example, a specific removable mass storage device commonly known as a CD-ROM typically passes data uni-directionally to the CPU 402, whereas a floppy disk may pass data bi-directionally to the CPU 402. Storage 412 may also include computer-readable media such as magnetic tape, flash memory, signals embodied on a carrier wave, PC-CARDS, portable mass storage devices, holographic storage devices, and other storage devices. A fixed mass storage 416 also provides additional data storage capacity and may be coupled bi-directionally to CPU 402 via peripheral bus 414. The most common example of mass storage 416 is a hard

disk drive. Generally, access to these media is slower than access to primary storages 404 and 406. Mass storage 412 and 416 generally store additional programming instructions, data, and the like that typically are not in active use by the CPU 402. It will be appreciated that the information retained within mass storage 412 and 416 may be incorporated, if needed, in standard fashion as part of primary storage 404 (e.g. RAM) as virtual memory.

In addition to providing CPU 402 access to storage subsystems, the peripheral bus 414 may be used to provide access other subsystems and devices. In an exemplary embodiment, these may include a display monitor 418 and adapter 420, a printer device 422, a network interface 424, an auxiliary input/output device interface 426, a sound card 428 and speakers 430, and other subsystems as needed.

A network interface 424 allows CPU 402 to be coupled to another computer, computer network, or telecommunications network using a network connection. Through network interface 424, it is contemplated that the CPU 402 might receive information, e.g., data objects or program instructions, from another network, or might output information to another network in the course of performing the above-described method steps. Information, often represented as a sequence of instructions to be executed on a CPU, may be received from and outputted to another network, for example, in the form of a computer data signal embodied in a carrier wave. An interface card or similar device and appropriate software implemented by CPU 402 can be used to connect the computer system 400 to an external network and transfer data according to standard protocols. That is, method embodiments of the present invention may execute solely upon CPU 402, or may be performed across a network such as the Internet, intranet networks, or local area networks, in conjunction with a remote CPU that shares a portion of the processing. Additional mass storage devices (not shown) may also be connected to CPU 402 through network interface 424.

Auxiliary I/O device interface 426 represents general and customized interfaces that allow the CPU 402 to send and, more typically, receive data from other devices such as microphones, touch-sensitive displays, transducer card readers, tape readers, voice or handwriting recognizers, biometrics readers, cameras, portable mass storage devices, and other computers.

Also coupled to the CPU 402 is a keyboard controller 432 via a local bus 434 for receiving input from a keyboard 436 or a pointer device 438, and sending decoded symbols from the keyboard 436 or pointer device 438 to the CPU 402. The pointer device may be a mouse, stylus, track ball, or tablet, and is useful for interacting with a graphical user interface.

In addition, embodiments of the present invention further relate to computer storage products with a computer readable medium that contain program code for performing various computer-implemented operations. The computer-readable medium is any data storage device that can store data that can thereafter be read by a computer system. The media and program code may be those specially designed and constructed for the purposes of the present invention, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter.

It will be appreciated by those skilled in the art that the above described hardware and software elements are of standard design and construction. Other computer systems suitable for use with the invention may include additional or fewer subsystems. In addition, memory bus 408, peripheral bus 414, and local bus 434 are illustrative of any interconnection scheme serving to link the subsystems. For example, a local bus could be used to connect the CPU to fixed mass storage 416 and display adapter 420. The computer system shown in FIG. 4 is but an example of a computer system suitable for use with the invention. Other computer architectures having different configurations of subsystems may also be utilized.

There has been described herein a system and method for non-SCCS files to an SCCS file repository. The system and method can automatically adapt non-SCCS file for an SCCS file repository. In addition, the system can generate a list of files from the non-SCCS file repository that were not adapted for the SCCS file repository to permit a system administrator to evaluate potential errors. The method is operable on a conventional computer processing device to create a system for adapting non-SCCS files to an SCCS file repository.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

What is claimed is:

1. A method for adapting non-SCCS files for use in an SCCS file repository, comprising:
receiving a plurality of non-SCCS files;
retrieving from an SCCS file repository files matching the received plurality of non-SCCS files;
comparing the received non-SCCS files to the SCCS files;
updating files in the SCCS file repository for which the non-SCCS files reflect changes; and
saving the updated files in the SCCS file repository.

2. The method of claim 1, wherein receiving a plurality of non-SCCS files comprises receiving a ZIP file.

3. The method of claim 1, further comprising determining whether any files from the SCCS file repository are checked out.

4. The method of claim 1, wherein retrieving from an SCCS file repository files matching the received plurality of non-SCCS files comprises scanning the SCCS file subdirectories for files that file names that match file names of the received non-SCCS files.

5. The method of claim 2, further comprising removing the non-SCCS files from the ZIP file and executing a dos2unix utility on one or more of the non-SCCS files.

6. The method of claim 1, wherein comparing the received non-SCCS files to the SCCS files comprises executing an SCCS diffs utility.

7. The method of claim 1 further comprising executing an SCCS unedit utility on the SCCS file if comparing the received non-SCCS files to the SCCS files indicates that the files are identical.

8. The method of claim 6, further comprising appending a newline string on the SCCS file if the SCCS diffs utility terminates with an error message indicating the newline string is missing.

9. The method of claim 1, further comprising generating a list of received files that do not match a file in the SCCS file repository.

10. A computer program product executable on a processor for adapting non-SCCS files for use in an SCCS file repository, comprising:
a computer usable medium having computer readable code embodied therein for managing resources, the computer usable medium comprising:
logic instructions for receiving a plurality of non-SCCS files;
logic instructions for retrieving from an SCCS file repository files matching the received plurality of non-SCCS files;
logic instructions for comparing the received non-SCCS files to the SCCS files;
logic instructions for updating files in the SCCS file repository for which the non-SCCS files reflect changes; and
logic instructions for saving the updated files in the SCCS file repository.

11. The computer program product of claim 10, wherein the logic instruction for receiving a plurality of non-SCCS files comprises logic instructions for receiving a ZIP file.

12. The computer program product of claim 10, further comprising logic instructions for determining whether any files from the SCCS file repository are checked out.

13. The computer program product of claim 10, wherein logic instructions for retrieving from an SCCS file repository files matching the received plurality of non-SCCS files comprises logic instructions for scanning the SCCS file subdirectories for files that file names that match file names of the received non-SCCS files.

14. The computer program product of claim 11, further comprising logic instructions for removing the non-SCCS files from the ZIP file and executing a 55 dos2unix utility on one or more of the non-SCCS files.

15. The computer program product of claim 10, wherein logic instructions for comparing the received non-SCCS files to the SCCS files comprises logic instructions for executing an SCCS diffs utility.

16. The computer program product of claim 10 further comprising executing an SCCS unedit utility on the SCCS file if comparing the received non-SCCS files to the SCCS files indicates that the files are identical.

17. The computer program product of claim 15, further comprising logic instructions for appending a newline string on the SCCS file if the SCCS diffs utility terminates with an error message indicating the newline string is missing.

18. The computer program product of claim 10, further comprising logic instructions for generating a list of received files that do not match a file in the SCCS file repository.

19. A system for adapting non-SCCS files for use in an SCCS file repository, comprising:
a network interface for receiving a plurality of non-SCCS files from a remote computing device; and
a processor adapted to execute logic instructions embodied on a computer readable medium, to retrieve from an SCCS file repository files matching the received plurality of non-SCCS files, to compare the received non-SCCS files to the SCCS files, to update files in the SCCS file repository for which the non-SCCS files reflect changes; and to save the updated files in the SCCS file repository.

20. The system of claim 19, wherein the processor is further configured to determine whether any files from the SCCS file repository are checked out.

21. The system of claim 20, wherein the processor is further configured to remove the non-SCCS files from the ZIP file and executing a dos2unix utility on one or more of the non-SCCS files.

22. The system of claim 19, wherein the processor is further configured to execute an SCCS diffs utility.

23. The system of claim 19, wherein the processor is further configured to execute an SCCS unedit utility on the SCCS file.

24. The system of claim 19, wherein the processor is further configured to generate a list of received files that do not match a file in the SCCS file repository.
